(19) United States
(12) Patent Application Publication
(10) Pub. No.: US 2004/0228266 A1
(43) Pub. Date: Nov. 18, 2004

(54) Digital animation disk

(76) Inventor: Kenneth Kingston Knight, Burbank, CA (US)

Correspondence Address: GREENBERG TRAURIG LLP, 2450 COLORADO AVENUE, SUITE 400E, SANTA MONICA, CA, 90404, US

(21) Appl. No.: 10/836,687

(22) Filed: Apr. 29, 2004

Related U.S. Application Data
(60) Provisional application No. 60/470,312, filed on May 14, 2003.

(51) Int. Cl. G11B 5/02

(52) U.S. Cl. 369/292

(57) ABSTRACT

A system provides flexibility on or with a work surface comprises a work surface which is generally planar with sides. A rotatable disk is located on or with or in the work surface such that the disk can be turned on an axis transverse, and preferably perpendicular, to the work surface. A work space area defined by the disk for accommodating a work zone is such that rotation of the disk permits the work zone to be rotated thereby to adopt different positions relative to the sides of the work surface. The work zone includes a digital working face or board, the board being permitted to move and rotate relative to the working surface under turning action by users.

### RELATED APPLICATIONS

This application claims priority to U.S. Provisional Application. No. 60/470,312 entitled “Digital Animation Disk”, filed on May 14, 2003, which is herein incorporated by reference in its entirety.

### BACKGROUND

This disclosure provides a system for facilitating work on a desk or worktop from different sides of the desk.

Different desk top situations are known. Essentially, a desk surface is a flat surface and workers are arrayed around the desk in different areas.

It is often difficult for persons on one side of the desk to work upside down or sideways with work product facing other persons on a different side of the desk.

This disclosure is directed to overcoming the disadvantages of reviewing work product from different angles.

### SUMMARY OF THE DISCLOSURE

A system of the disclosure provides flexibility when using a digital working board to permit movement and rotation of the working surface on demand. This facilitates use by creators of animation.

A digital animation disk for providing a 360 degree working surface for a WACOM (trademark) board for facilitating digital layout and animation comprising a surface for accommodating a digital unit, the surface being rotatable about an axis such that the digital unit is rotatable.

It is thereby usable by persons located around a desk so that the disk and elements mounted with the disk can be turned to face upright or in a correct forwards orientation relative to users located at different locations around the desk.

The animation disk is preferably a circular disk for location in relation to a desk work surface. There is a cut out in the desk for receiving the disk. The cut out includes a peripheral lip for supporting the periphery of the disk which is a board like element. The cut out includes a substantially rectangular shaped lip circumferentially around the cut out thereby to mate with a rectangular lip circumferentially about the rear periphery.

The disk is substantially circular. There is a cut out centrally located in the disk. In the surface of the disk there is at least one finger hole to facilitate the turning of the disk about a central rotational axis. There are also one or more apertures for accommodating a stylus. The finger holes can be at the top and the bottom of a rectangular aperture for receiving the board, monitor or screen.

The disk can be formed of two parts thereby forming the lip. The front or top portion can be of a wider diameter, for instance 24 inches, and the base diameter can be about 22 inches.

This cut out rotational disk can be used for other boards, monitors or the like. The circular disk can be located on a desk or in an aperture of a desk.

The disclosure is further described with reference to the accompanying drawings.

### BRIEF DESCRIPTION OF THE DRAWINGS

FIG. 1 is a top perspective view of a desk or working surface with a circular digital animation disk formed in the surface.

FIG. 2 is a top perspective view of the desk surface with the disk removed from its location.

FIG. 3 is a cross-sectional side view of the disk with the disk in position.

FIG. 4 is a top view of the disk with the disk in position showing its different possibilities for rotational movement.

### DETAILED DESCRIPTION OF THE DISCLOSURE

A system provides flexibility relative to a work surface and comprises a work surface which is generally planar with a perimeter. There is a rotatable disk for location in at least one of being on, with or in the work surface. The disk can be turned on an axis transverse to the work surface. There is a work space area defined by the disk for accommodating a work zone such that rotation of the disk permits the work zone to be located in different positions relative to the work surface.

The work zone includes a digital working face or board, the working face or board being rotatable relative to the working surface under turning action by users. The digital working face is an animation disk providing a 360 degree working surface board for facilitating digital layout and animation. The animation disk can be a circular disk for location in relation to a desk work surface. There is a cut out in the desk for receiving the disk.

As such there is provided a digital animation disk with enhanced features.

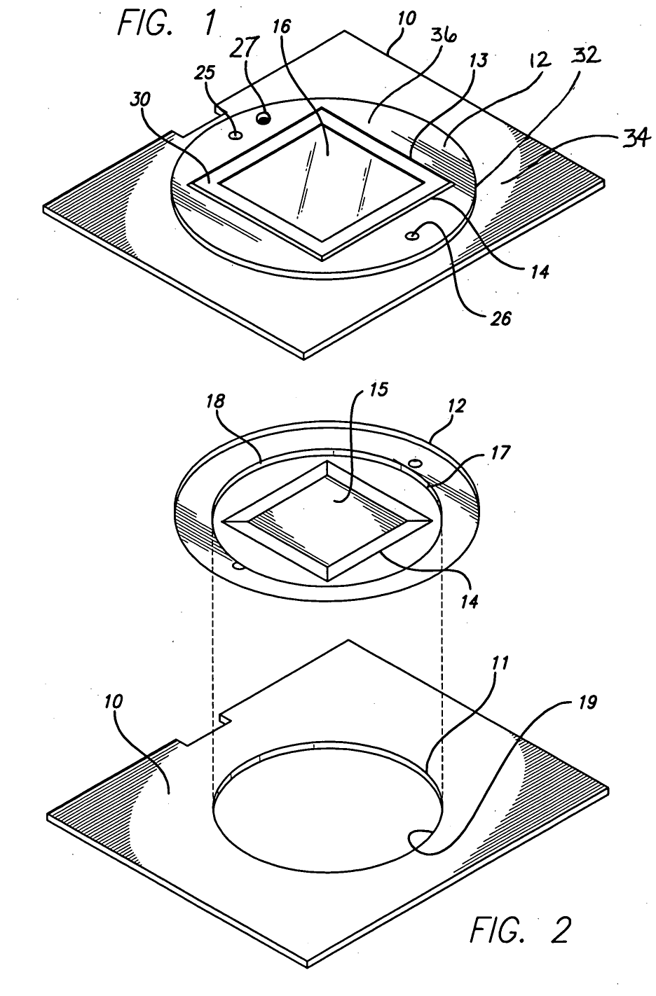

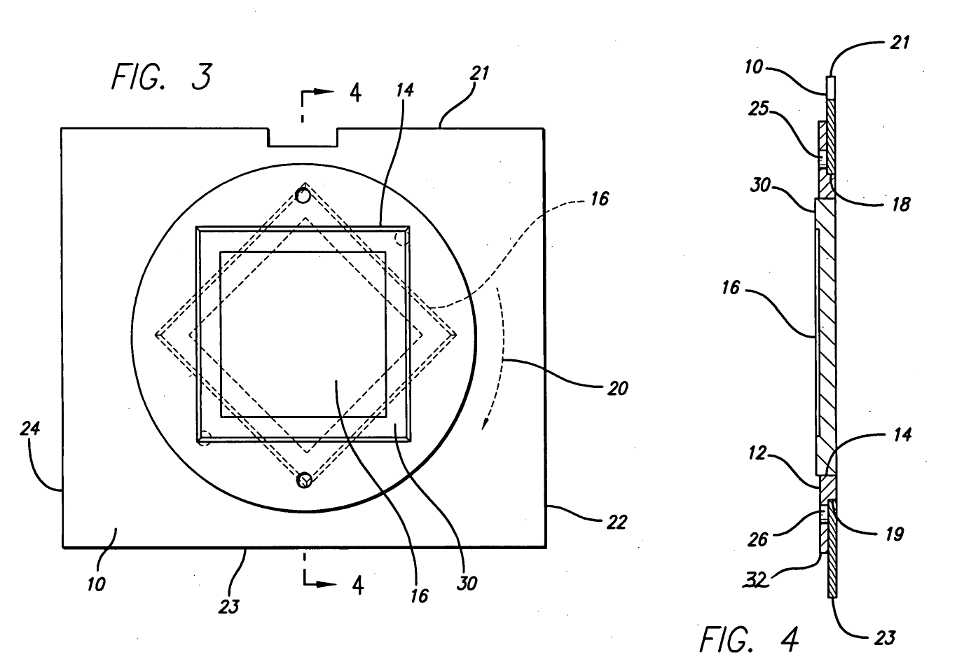

FIG. 1 shows a disk or working surface 10 with a cut-out 11 into which can be located a digital animation disk 12. Within the digital animation disk there is a board, working screen or monitor 30 which fits into a cut-out portion 14 formed in the rotational disk. The rear 15 of the screen 30 can be seen in the underview of the disk 12 as shown in FIG. 2. The top face 16 of the working screen or in the alternative a board 30 can be seen in FIG. 1. The diameter of the disk 12 can be about twenty-four inches in the outer top diameter and can have a recessed section 17 which forms a step 18. The step 18 engages on the inside step 19 of the disk 10. As such, the disk 12 can rotate as indicated by arrow 20 with the steps 18 and 19 interengaging. As such the screen 16 can be directed to face anyone of the ends 21, 22, 23 or 24 of the work desk 10.

Apertures 25 and 26 are provided for receiving a stylus or a finger to facilitate rotation of the disk in the aperture 11 as the case may be. A suitable writing surface can be provided over the screen 16 which can either include a pen or a stylus or other kind of electronically active unit to give input to the monitor which is in turn connected to a computer as the case may be. Aperture 27 is provided for stylus storage.

The size of the disk can vary directly or proportionally according to the size and shape of the digital unit to be inserted in the disk. If necessary the slot for receiving the monitor can vary or be suitably hollowed out to recess the monitor below or level with the overall surface of the desk as preferred. There may be a second recess or a step provided in the working surface 10 so that the disk can be inset in the surface 34 to permit the disk 12 to be essentially flush with the surface 34 or a different depth, above or below, relative to the surface 34.

There can be different glides, rollers or the like provided to facilitate the movable situation of the parts. In some cases there may not be a screen or board and the work surface 36 is the surface about which the persons work. Instead of the sides being of a rectilinear nature they could be curved or circular. Instead of an animation desk this structure can have other uses in a work surface for different purposes.

Many other forms of the disclosure exist, each differing from the others in matters of detail only.

We claim:

1. A system for providing flexibility relative to a work surface comprising:
a work surface which is generally planar with a perimeter;
a rotatable disk for location in at least one of being on, with or in the work surface such that the disk can be turned on an axis transverse to the work surface; and
a work space area defined by the disk for accommodating a work zone such that rotation of the disk permits the work zone to be located in different positions relative to the work surface.

2. A system as claimed in claim 1 wherein the work zone includes a digital working face or board, the working face or board being rotatable relative to the working surface under turning action by users.

3. A system as claimed in claim 2 wherein the digital working face is an animation disk providing a 360 degree working surface board for facilitating digital layout and animation.

4. A system as claimed in claim 3 wherein the animation disk is a circular disk for location in relation to a desk work surface, and including a cut out in the desk for receiving the disk.

5. A system for providing flexibility relative to a work surface comprising:
a work surface which is generally planar;
a rotatable disk for location relative to the work surface such that the disk can be turned on an axis transverse to the work surface;
a work space area defined by the disk for accommodating a work zone such that rotation of the disk permits the work zone to be rotated thereby to adopt different positions relative to the sides of the work surface.

6. A system as claimed in claim 5 wherein the work zone includes a digital work face or board, the face and board being permitted to rotate relative to the working surface under turning action by users.

7. A system as claimed in claim 6 wherein the digital work face is an animation disk providing a 360 degree working surface board for facilitating digital layout and animation.

8. A system as claimed in claim 7 wherein the animation disk is a circular disk for location in relation to a desk work surface, and preferably includes a cut out in the desk for receiving the disk.

9. A system for a digital animation disk comprising:
a work surface which is generally planar with a perimeter;
a rotatable disk for location in at least one of being on, with or in the work surface such that the disk can be turned on an axis transverse to the work surface; and
a work space area defined by the disk for accommodating a work zone such that rotation of the disk permits the work zone to be located in different positions relative to the work surface.

10. A system as claimed in claim 9 wherein the work zone includes a digital animation disk includes an animation surface rotatable relative to the working surface under turning action by users.

11. A system as claimed in claim 10 wherein the digital animation disk provides a 360 degree working surface board for facilitating digital layout and animation.

12. A system as claimed in claim 11 wherein the animation disk is a circular disk for location in relation to a desk work surface, and including a cut out in the desk for receiving the disk.

13. A system as claimed in claim 1 including a step for accommodating the disk in the work surface.

14. A system as claimed in claim 1 wherein the rotatable disk is relatively stationary to the work space, work zone and work board.

15. A system as claimed in claim 1 including slots in the disk for accommodating tools.

16. A system as claimed in claim 1 including at least one facility with the disk for receiving a finger of a user to facilitate turning of the disk.
